(19) United States
(12) Patent Application Publication
(10) Pub. No.: US 2015/0072048 A1
(43) Pub. Date: Mar. 12, 2015

(54) METHOD FOR PREPARING A PET FOOD PRODUCT FOR A PET AND PET FOOD PRODUCT PREPARED USING THIS METHOD

(71) Applicant: futalis GmbH, Leipzig (DE)

(72) Inventors: Janes Potthoff, Leipzig (DE); Stefanie Schmidt, Leipzig (DE); Christian Hetke, Leipzig (DE)

(73) Assignee: futalis GmbH, Leipzig (DE)

(21) Appl. No.: 14/394,183

(22) PCT Filed: Apr. 4, 2013
(86) PCT No.: PCT/EP2013/057727

§ 371 Date: Oct. 13, 2014

(30) Foreign Application Priority Data
Apr. 12, 2012 (DE) 10 2012 007 310.0

(51) Int. Cl. G06Q 30/06; A23K 1/18

(52) U.S. Cl. CPC G06Q 30/0621; A23K 1/18
USPC 426/87; 705/26.5

(57) ABSTRACT

The invention relates to a method for preparing a pet food product for a pet, in which pet-specific information is provided and processed, a set of pet-specific food compositions is created from the processed information on the basis of the processed pet-specific information, and a pet food product is produced on the basis of the set of pet-specific food compositions. According to the invention, the pet food product consists of a combination of a plurality of rations, each having an assigned time.

The present invention relates to a method for providing a pet food product for a pet, as well as a pet food product for a pet, which is prepared using said method. In particular, the present invention relates to a method for preparing a pet food product for a pet using pet-specific information to produce a pet food product based on said information.

### PRIOR ART

There are known methods for providing a pet food product for a pet where the pet food is mixed based on the preferences of a pet owner. Veterinary aspects are ignored or play a lesser role with these methods.

Also, there are known standard products, which are offered in groups, taking into account certain criteria for the pet. For example, pet food for young dogs, for old dogs, for pregnant dogs, for certain breeds, etc. is being offered.

The object of the present invention is to provide a method for preparing a pet food product for a pet, which on the one hand is adapted individually to the pet's needs and on the other hand simplifies the use for the pet owner. Furthermore, it is the object of the present invention to provide an appropriate pet food product for a pet, which offers the aforementioned advantages.

According to the invention, the object is attained with a method for preparing a pet food product for a pet, having the characteristics of claim 1, and/or a pet food product for a pet, having the characteristics of claim 17.

According to the basic concept of the present invention, a method for providing a pet food product for a pet comprises the following steps:
Providing pet-specific information;
Processing the pet-specific information;
Preparing a set of pet-specific pet food compositions based on the processed pet-specific information;
Preparing a pet food product based on the set of pet-specific food compositions.

According to the invention, the pet food product is comprised of an assortment of multiple rations, each of which has an assigned time.

With the method according to the invention, pet-specific information is provided and processed accordingly. The pet-specific information relates to the pet's characteristics, the pet's individual state and/or the pet's individual living conditions. Based on the processed pet-specific information, a set of pet-specific food compositions is created. Said set of pet-specific food compositions is used to prepare a pet food product.

Therefore, the method according to the invention is used to prepare a pet-specific pet food product that takes into account the provided pet-specific information.

According to the basic concept of the present invention, the pet food product consists of an assortment of multiple rations, each of which has an assigned time. Therefore, on the basis of the set of pet-specific pet food compositions, an individualized product is prepared, which is not simply offered to the pet non-specifically; rather, the method according to the invention takes into account the pet's feeding time by providing rations that are linked to an assigned time, which the pet owner can take into account when feeding the pet. In this context, the quantity of food to be fed to the pet during a certain time frame is taken into account when preparing the rations, and therefore each ration contains a predetermined quantity of food. This method results in the option of aiding the pet owner in the feeding of his pet by providing rations with an assigned time; optionally, the food composition of individual rations, which are labeled with the assigned time, can be specified according to the pet-specific information. Therefore, the pet-specific information is not only taken into account when preparing the pet food product, but the provision/production of the pet food product also includes a time component that makes particular sense for the pet from a physiological aspect.

According to a preferred embodiment of the present invention, the pet owner provides the pet-specific information. Generally, the pet owner knows the pet-specific information and therefore having the pet owner provide the pet-specific information is especially efficient. Furthermore, the pet owner can influence the pet-specific information because of his interaction with the pet and therefore, providing pet-specific information through the pet owner can represent a particularly accurate depiction of the individual pet's needs.

According to a preferred embodiment of the present invention, the rations are packed individually and each is labeled with information about the assigned time. The information regarding the assigned time can be printed on the packages of the individual rations or applied or attached in another way to make the use of the prepared pet food product particularly easy for the pet owner. It is not necessary to affix the assigned times to the packaging as long as the assigned time is taken into account when preparing the rations.

According to a preferred embodiment of the present invention, the food quantity and/or the food composition of the individual rations in the pet food product is individually adapted taking into account the respective assigned time. With this option, the pet can be fed or offered the optimal content substances in an agreeable manner. In particular, each ration contains a predetermined quantity of food and/or a predetermined food composition so that the pet food product can optimally cover the pet's needs when used as directed.

According to a preferred embodiment of the present invention, the assigned time of the respective rations comprises a specific day, in particular a specific day of the week. Preferably, the pet can be fed daily. Providing the respective rations for a specific day therefore can be adapted to the usual feeding cycle of pets. When providing the daily rations, the pet owner retains the overview of the food quantity that is being fed, while at the same time not being subjected to an excessive number of different rations. According to the invention, the pet food product consists of a number of rations, each of which is prepared for a specific day according to said embodiment example. Optionally, the pet food product can be provided for a week, with the pet food product then consisting of seven rations for a specific day of the week. However, according to the invention, deviating from the individual rations for a specific day is possible; in particular, it is possible to prepare multiple rations for one day, with the optional information regarding the assigned time then being adapted correspondingly and also including, in addition to the day, a reference to the time of day. There is also the possibility of adapting the pet food product not for a week, but for a month or for a particularly advantageous time period.

According to a preferred embodiment of the present invention, the pet food product, which consists of a set of rations, is commissioned and provided to the pet owner, in particular by shipping. The pet food product, which consists of a set of rations, is easy to handle and can be easily commissioned and provided to the pet owner by combining the rations. The can occur at a store, a pharmacy, a doctor's office, or the like. Shipping the pet food product, which consists of a set of rations, to the pet owner is especially advantageous.

According to a preferred embodiment of the present invention, the pet-specific information provided by the pet owner is entered via an electronic interface, in particular a web-based portal. An electronic interface offers optimal conditions for entering qualitative and quantitative information related to the pet. The electronic interface can be any means capable of transmitting data with respect to the pet-specific information in such a manner that the data can be, in particular, centrally evaluated for preparing the pet food product for the pet. In this context, the use of a web-based portal is particularly advantageous because the Internet is especially easy and advantageous for the pet owner to transmit information. Furthermore, there is the option of storing and evaluating the entered information in an individualized database. This evaluation can also be made available to the pet owner to give him an overview of the physiological nutritional state of his pet. Furthermore, the web-based portal can be provided with an ordering function for the pet food product in the usual manner. It is furthermore possible to provide a payment option in the web-based portal.

According to a preferred embodiment of the present invention, the set of pet-specific information includes one or more of the following details:
Type of domestic pet;
pet's breed;
pet's age;
pet's name;
pet's diseases;
pet's allergies;
pet's intolerances;
pet's predispositions;
pet's size;
pet's physiological stress profile;
pet's breeding profile;
pet's lactation week;
pet's number of puppies;
pet's weight;
pet's nutritional state;
genetic information related to the pet.

The following explains some of the aforementioned terms to facilitate an understanding of the concept of the invention, but without representing any limitations.

Type of Domestic Pet

This refers to a biological species. Examples are the species of “dog”, “cat” or “horse.” The designation is either in text form or in form of a clearly attributable icon.

Pet's Breed

Breed describes a more specific breakdown of the individual species into various breeds.

According to the criteria of official breeding associations, this includes, for example, the breed standard, officially recognized breeds for dogs, but also breeds that have not yet been officially recognized.

Pet's Photograph

A photograph associated with the pet. This can be a photograph of the species/breed or an individual photograph.

Pet's Age

The age of the pet is entered by providing the birth year and/or month/day and represented as the lifespan to date in weeks, months or years. This can be additionally broken down into age groups (such as puppy, foal, adult, senior, for example). Age groups can be reported in text form or by an icon assigned to the group.

Name of the Pet

The name is understood to be the name used in the daily interaction with the pet or its pet name, as well as the name of the pet entered into official breeding registries and documents (domestic pet ID, equine ID, etc.).

Pet's Physiological Stress Profile

This is broken down either into predefined activity groups or recorded as exact information about the animal's physical activities, such as kilometers traveled per day or time per gait (walking, trotting, galloping, . . . ) and/or the type of activity (sled race, agility, hunting, dressage training, jumping, endurance ride, . . . ). The degree of activity can also be assigned by a defined image.

Pet's Gender

In addition to the biological gender (male, female) this also includes any potential procedure that reduces the formation of sex hormones or the ability to breed, such as castration or sterilization. For assigning gender, in addition to the terms “male” and “female”, designations specific to the type of pet (such as male dog, bitch, tomcat, stallion, mare, gelding) or generally valid symbols (Mars symbol, Venus symbol) are used.

Pet's Diseases

Diseases comprise a great number of potential physical health issues of the respective animal. This can be illness diagnosed by the treating veterinarian, but also symptoms noticed by the pet owner, which are transmitted. The assignment can be made with the precise designation of the illness/the symptom, by group association, or by symbols.

Pet's Allergies

Allergies are immunological reactions of the body to various substances that act as allergens. The pet owner will list known and/or suspected allergens, or provide test results and list the allergy by name or symbol.

Pet's Intolerances:

Intolerances refers to pet food that when ingested in a certain quantity leads to local reactions in the gastrointestinal tract. Information is provided on substances that are known to lead to intolerances, or are suspected of leading to intolerances. They are represented in text form or by symbols.

Pet's Predispositions:

Predispositions refer to an affinity to diseases due to the genetic makeup of the respective pet and to statistically increased disease risks as well as metabolic anomalies (such as a lack of enzymes, for example). The association can be made by textual description or use of a symbol (icon).

Pet's Size:

The size describes the precise metric dimensions of special external body parts (such as: withers of the horse, shoulder height of the dog) as well as its categorization into size categories commonly used for the type of pet (such as pony up to 148 cm; for dogs dwarf breeds up to 30 cm).

Pet's Breeding Profile:

For male and female animals, it is specified whether the animals are generally used for breeding purposes. Furthermore, the current reproductive status is noted. This includes, for example, the breeding service, the insemination status, a pregnancy (with information on the progression) or lactation. The status is named or stated with a symbol.

Pet's Lactation Week:

The lactation time, e.g. the suckling of the young with the mother's milk, is divided into various stages, which are named either by providing time information, such as weeks or months past birth, or time periods (such as high lactation, late lactation).

Pet's Number of Puppies:

The number of littermates for animals generally having plural litters. This may be the actual number of puppies, or an expected or statistically determined value.

Pet's Weight:

The weight can be a value determined by a current weighing or a statistically determined value for the respective animal. This also includes estimates and information obtained with other measurements (such as with the help of the formula by Carroll & Huntington after determining the horse's tapeline) in generally applicable weight units.

Pet's Nutritional State:

The nutritional state is assigned either by subjective estimation, by numerical deviation of the current weight from the optimal weight, or by commonly used scoring systems (such as Body Condition Score, for example), including a description of the appearance (such as the type and quantity of fatty deposits or the visibility/palpability of projecting bones). Categorization can be done using a number value, a description, or a representative image or symbol.

According to another preferred embodiment of the present invention, the set of pet-specific information is processed taking into account veterinary guidelines. In particular, the information is evaluated to determine whether certain components of the food composition have to be adapted appropriately to meet the requirement of an adequate diet for the pet. Preparing the set of pet-specific information furthermore comprises the weighing of contradictory quantitative or qualitative information. Therefore, preparing the set of pet-specific information comprises on the one hand the assessment of the information from empirical data and on the other hand the calculation of the food composition based on formula correlations, for example.

When the pet owner enters the data, the entered data can be validated for consistency to recognize implausible entries immediately and correct them prior to determining the demand value. For example, this includes inconsistent entries regarding the nutritional state in connection with information on the current weight as well as the goal weight. Furthermore, the process questions are generated dynamically and adapt to the information that was provided. This includes first of all that the pet owner is not confronted with irrelevant questions, and secondly that the optimal data are transmitted into the demand value determination.

According to a preferred embodiment of the present invention, creating the set of pet-specific pet food compositions includes the selection from semi-finished products and/or raw materials. The pet food compositions of the rations can be influenced by the selection of semi-finished and/or raw materials. In particular, the pet's allergies and intolerances can be taken into account by avoiding certain raw materials. Furthermore, specific diets can be created when selecting or avoiding semi-finished products that correspond to the specified requirements.

According to a preferred embodiment of the present invention, the set of pet-specific pet food compositions is prepared in an automated fashion. In particular, the information can be evaluated using a computer. To that end, it is especially advantageous on the one hand for the pet owner to provide quantifiable information, and on the other hand to specify qualitative information using a quantified assessment scale. These data can be processed using a computer, with the result being that a set of pet-specific pet food compositions can be created, which then can be used for the preparation of the pet food product.

According to a preferred embodiment of the present invention, the creation of the set of pet-specific food compositions is optimized by way of manual intervention. This ensures that on the one hand obviously unfavorable food compositions can be avoided based on the empirical data or specific experiences of trained personnel, and on the other hand, the individual food compositions can be optimized based on the specialized knowledge.

According to an especially preferred embodiment of the present invention, supplementary feeding to complement the provided pet food product is taken into account when creating the set of pet-specific food compositions. In certain situations, the pet owner will offer the pet supplementary food in addition to the pet food product prepared according to the invention. However, said supplement affects the entire nutritional intake with respect to the substance composition and the total quantity of food. Therefore, taking said supplemental feedings into consideration optimizes the entire nutritional intake and/or the entire diet offered to the pet. The pet owner can make available the additional feedings optionally in conjunction with the pet-specific information.

According to a preferred embodiment of the present invention, recommendations for species-specific supplemental feeding, species-specific products and/or species-specific services are determined based on the pet-specific information and in particular, said recommendations are provided to the pet owner together with the pet food product. Said recommendations can be given to the pet owner together with pet food product as additional information. Optionally, the recommendations can be printed on the packaging of the individual rations. Alternately, the recommendations can be communicated to the pet owner via the web-based portal. The pet owner does not have to accept the recommendations. However, if the recommendations are accepted in that the pet owner feeds the pet a species-specific supplemental pet food according to the recommendations, this can be taken into account advantageously when the pet-specific information is provided and therefore the pet food product can be adapted.

According to a preferred embodiment of the present invention, the individual packages of rations that are assembled as pet food product are labeled with at least one of the following details:
Name of the individual pet;
at least part of the pet-specific information;
information about the food composition and/or the food quantity of the individually packaged ration;
information on the assigned time of the individually packaged ration.

This list of information is not conclusive and can include other information of certain relevance to the pet owner. Optionally, the pet owner can select at least part of the information to receive only the information that he wants to receive.

This information allows for an individualization of the pet food product. At the same time, the information facilitates the use of the pet food product for the pet owner and furthermore ensures the correct use of the pet food product.

According to a preferred embodiment of the present invention, the pet food product consists of a week's worth of individually packaged daily rations. Therefore, the pet owner is provided a pet food product at appropriate time intervals to avoid on the one hand too frequent pickups/requests for the pet food product and on the other hand, there is still sufficient flexibility to adapt the pet food product to the changing requirements of the pet.

According to the invention, a pet food product for a pet is provided from an assortment of multiple rations, each of which has an assigned time, with the pet food product being provided and produced with a method as described above.

### Examples of Embodiments

Embodiments of the present invention are explained taking into account the attached drawings.

### BRIEF DESCRIPTION OF THE DRAWINGS

FIG. 1 is a schematic representation of the process of the method according to the invention for providing a pet food product, according to a first embodiment.

FIGS. 2 to 7 show additional embodiments of the invention as modifications of the first embodiment.

### DESCRIPTION OF THE EMBODIMENT EXAMPLES

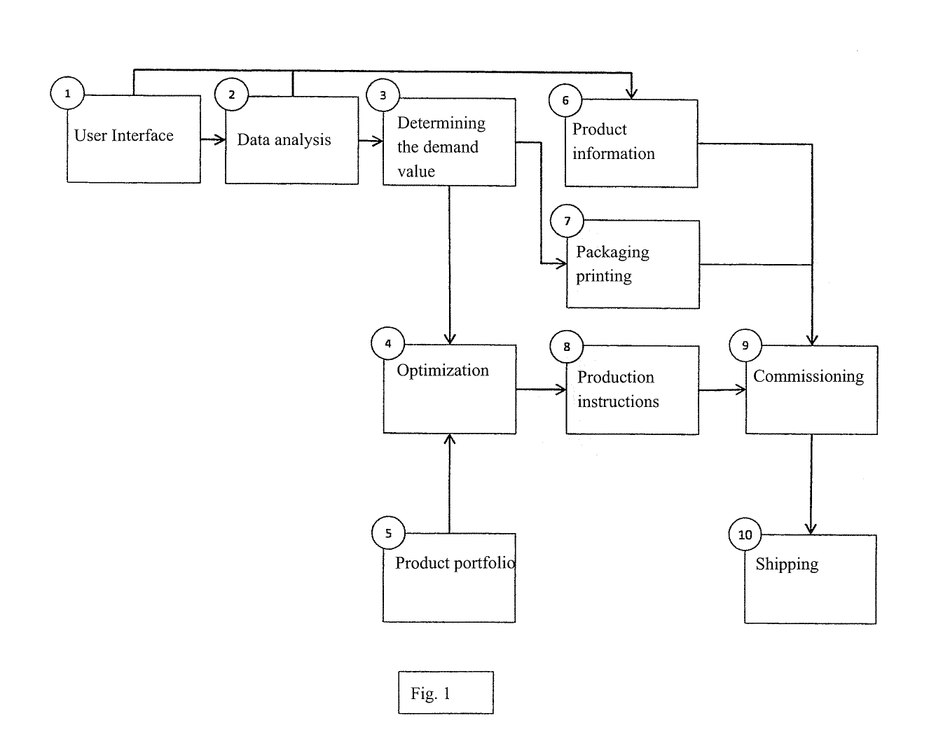

FIG. 1 shows a schematic representation of the method according to the invention in a first embodiment example of the invention. In that and in all other figures, the steps are numbered and the description makes reference to said numbers.

At the beginning of the process (Step 1), the pet owner enters the relevant data for his pet into an interface, where the pet owner is guided in an optimally scientific validated question process to provide pet-specific information. This includes the type of domestic pet; pet's breed; pet's age; pet's name; pet's degree of activity; pet's gender; pet's diseases; pet's allergies; pet's intolerances; pet's predispositions; pet's size; pet's breeding profile; pet's lactation week; number of pet's puppies; pet's weight; pet's nutritional state.

This list is not conclusive and can be supplemented with additional information. Furthermore, it is sufficient to query a selected part of this information and use it as long as the goal of the invention is achieved.

The anamneses process can be guided through a web-based portal based on conventional web technologies such as Javascript or HTML5, for example also in connection with a shopping system such as Magento, for example. The user can perform the method through access via a stationary electronic data processing system or also via a mobile terminal device. Furthermore, the pet owner can be given assistance in the scope of the anamneses to help him answer the questions. Said assistance can be provided in form of information boxes or also in form of a parallel expert chat, which the user can contact if questions are unclear and/or expert support is desired in answering the questions. The expert chat can be triggered either actively by clicking on a radio button, or it can be initiated by the expert, for example when the user is inactive, which is identified by analytical programs such as Google Analytics, for example.

During or after the data being entered by the pet owner, the entered data is validated for consistency so that implausible entries can be recognized immediately and corrected before the demand value is determined. For example, this includes inconsistent entries regarding the nutritional state in connection with information on the current weight or target weight. Furthermore, the process questions can be generated dynamically and will therefore adapt to the information that was provided. First of all, this ensures that the pet owner is not confronted with questions that are irrelevant to him, and secondly, the optimal data is transferred into the demand value determination. For example, the options for stating the weight for a puppy are strongly adjusted relative to an adult animal. Furthermore, breeding animals are treated differently than animals that are not used for breeding, and treated dynamically in the process.

When the user entry (Step 1) and the data analysis (Step 2) are completed, the demand values are determined (Step 3). To that end, the collected and validated entry data is compared to statistical data from a database and a value is determined, based on researched correlations applying scientific formulae for various elements of the energy—and nutritional needs. In doing so, the demand values for the following elements are collected: ME_Hund [dog]; raw protein (vRp); dry substance (DM); raw fat (Rfe); NfE; raw fiber (Rfa); calcium (Ca); phosphor (P); magnesium (Mg); potassium (K); sodium (Na); iron (Fe); copper (Cu); zinc (Zn); vitamin A; vitamin D3; vitamin E, with this list representing only an excerpt of the demand value collection and not being considered conclusive. Even a part of said demand values is sufficient as long as the object of the invention is achieved. Furthermore, in addition to the target demand value, tolerances for each value are determined according to the same method. Then the values are standardized and released for calculation.

The calculation algorithm that then follows for optimization (Step 4) is based on evolutionary functions that feed from the available products (Step 5) the optimal composition for the determined demand values (Step 3). In doing so, programming languages such as C; Java or Fortran can be used. Great emphasis is placed on correctness from a veterinary medicine aspect. The pet owner cannot directly influence the calculation and its outcome. At the end of the calculation and optimization process a set of rations for several days (Step 6) is outputted to the owner, with each including information about the composition as well as the correlating optimum food quantity. The data are processed simply and visually and presented to the pet owner in suitable form. A web-based portal is particularly suitable for this; the information can also be sent via letter or email. Furthermore, the pet owner can take advantage of an expert chat for explanation of the information. He can furthermore contact the expert office hours by phone and also access all information at a later date in his user backend.

On the basis of the calculated optimized composition, the production instructions are forwarded to Production (Step 8). Said production instructions are similar to a recipe and include the respective quantity of each basic material (raw material or semi-finished product) for each ration. These mixing directions can be printed on paper and sent to an employee for manual mixing, or they can be forwarded to the employee virtually (overhead screen or portable handheld computer). Furthermore, it is possible to forward a control signal to a fully automated mixing device, which then individually mixes each calculated ration an fills it into ready-to-ship packaging.

In either case, during commissioning, each individual ration is mixed individually according to the production instructions (Step 8) (or a larger quantity is prepared and the respective quantity is taken from the homogenous quantity). For example, a ration of nine individual components may consist of different quantities, with the quantity of each individual basic substance varying from ration to ration. Each ration is labeled with a unique lot number to be able to track the raw materials.

Furthermore, each ration is labeled with additional product information from the packaging printing (Step 7), which provides the pet owner detailed information about the respective ration, its purpose and its composition, and exceeds what is required by law.

In addition, together with the product, the pet owner receives additional information about the composition, care instructions and further individualized customer-specific information.

After commissioning is completed (Step 9), the ration package, which represents the pet food product, can be shipped to the customer (Step 10) or to the respective veterinarian or pharmacy. Furthermore, the customer has the option of picking up the package directly at the company or an affiliate.

### Second Embodiment Example

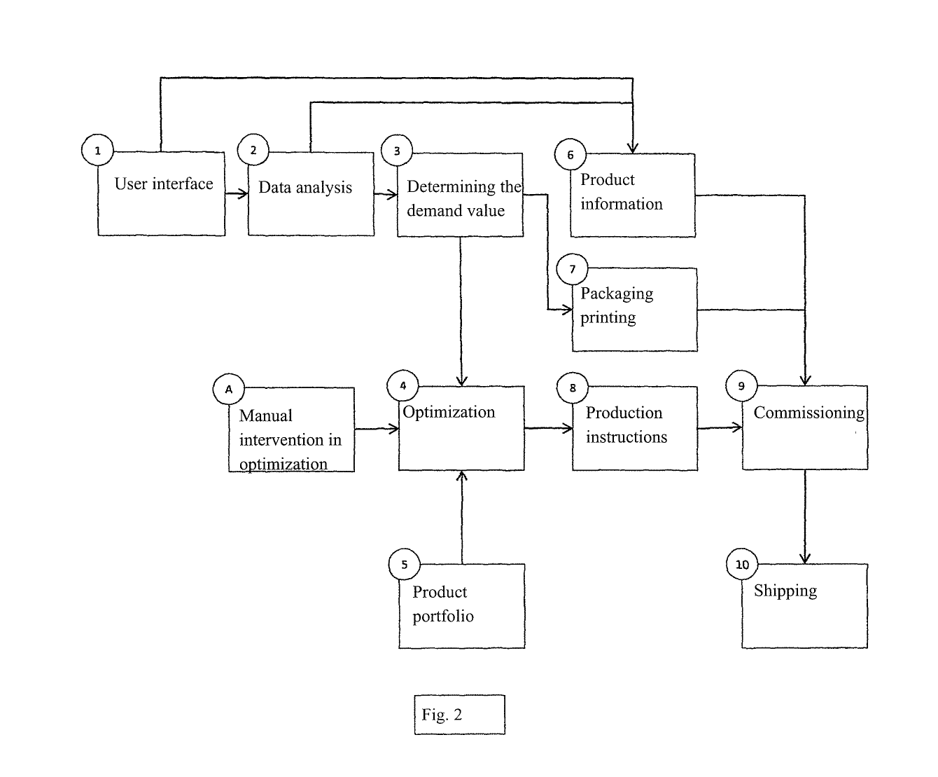

The second embodiment represented schematically in FIG. 2 follows the method of the first embodiment example. In addition to the first embodiment example, the user has the option of making manual changes to the proposed solution after the optimization (Step A). For example, a veterinarian can additionally apply his professional expertise and knowledge of his patient to the product composition. This raises the degree of individualization even higher.

### Third Embodiment Example

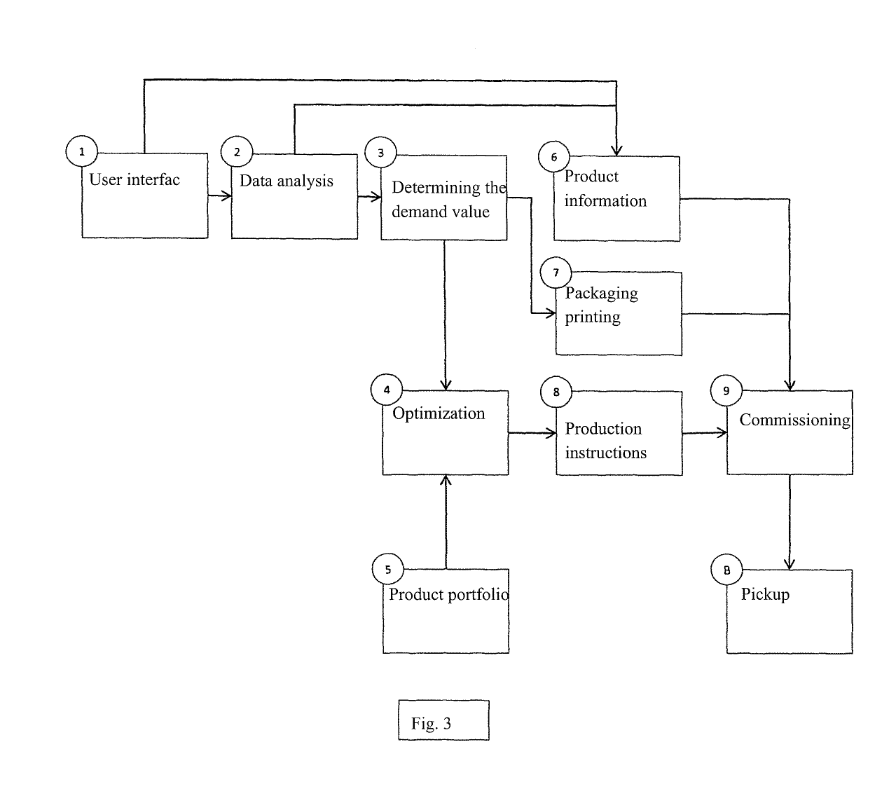

The third embodiment example represented schematically in FIG. 3 follows the method of the first embodiment example. Alternately to the first embodiment example, the package is not mailed to the pet owner but rather picked up, for example at a pharmacy, a veterinarian's office, specialized stores or at another affiliate location (Step B).

### Fourth Embodiment Example

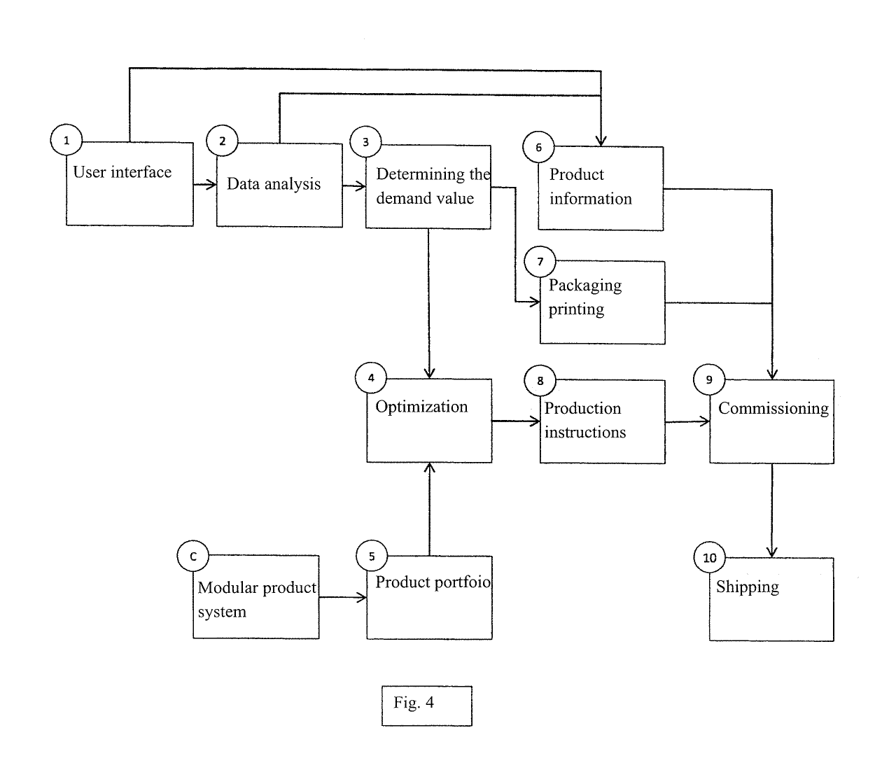

The fourth embodiment example represented schematically in FIG. 4 follows the method of the first embodiment example. In addition to the first embodiment example, the product portfolio can consist of semi-finished products or raw materials (Step C). It can be structured such that the modular composition in terms of an ABC analysis allows a cost-efficient mixing of the rations and is optimized with respect to inventory.

### Fifth Embodiment Example

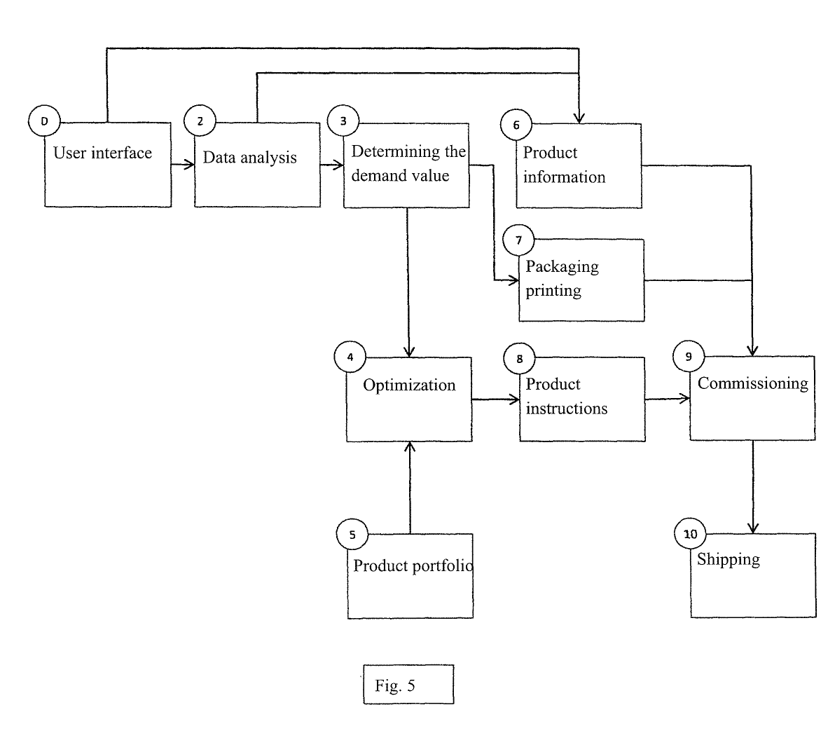

The fifth embodiment example represented schematically in FIG. 5 follows the method of the first embodiment example. Alternately or in addition to the first embodiment example, in addition to a portal or hotline, the data can also be entered at a terminal in a shop, at the veterinarian's office or in a pharmacy (Step D). The data can be entered by the pet owner himself or by a skilled employee.

### Sixth Embodiment Example

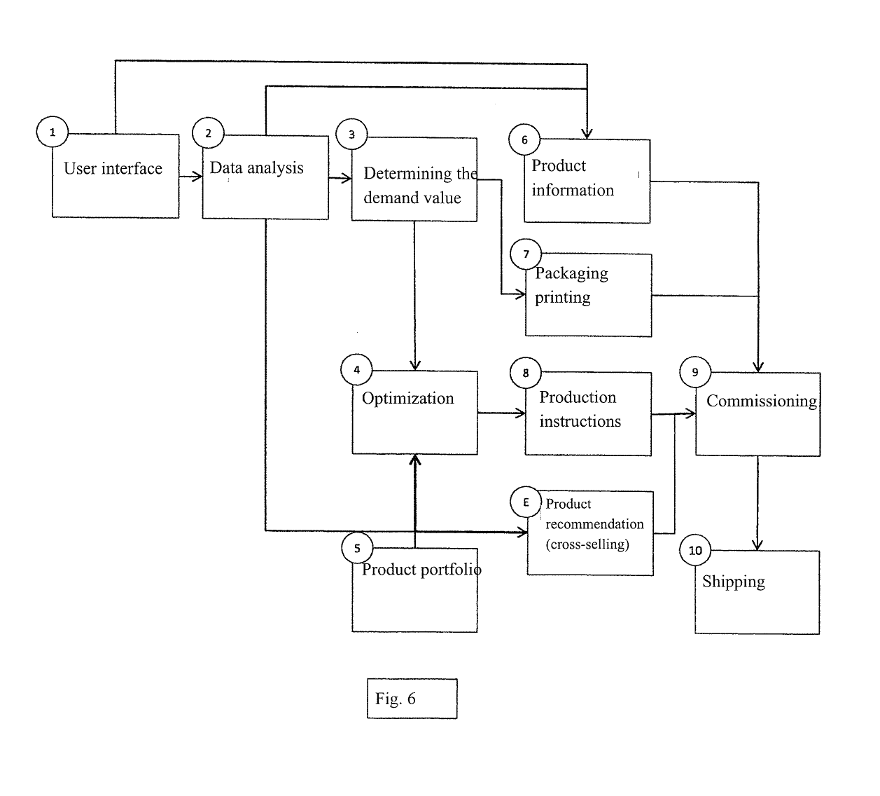

The sixth embodiment example represented schematically in FIG. 6 follows the method of the first embodiment example. Alternately or in addition to the first embodiment example, in addition to the ration recommendation, other products can be recommended to the pet owner, which can be taken into account either in form of suitable supplemental food when calculating the rations, or are additional demand items based on the user input, and are adapted to the individual needs of each pet (Step E).

### Seventh Embodiment Example

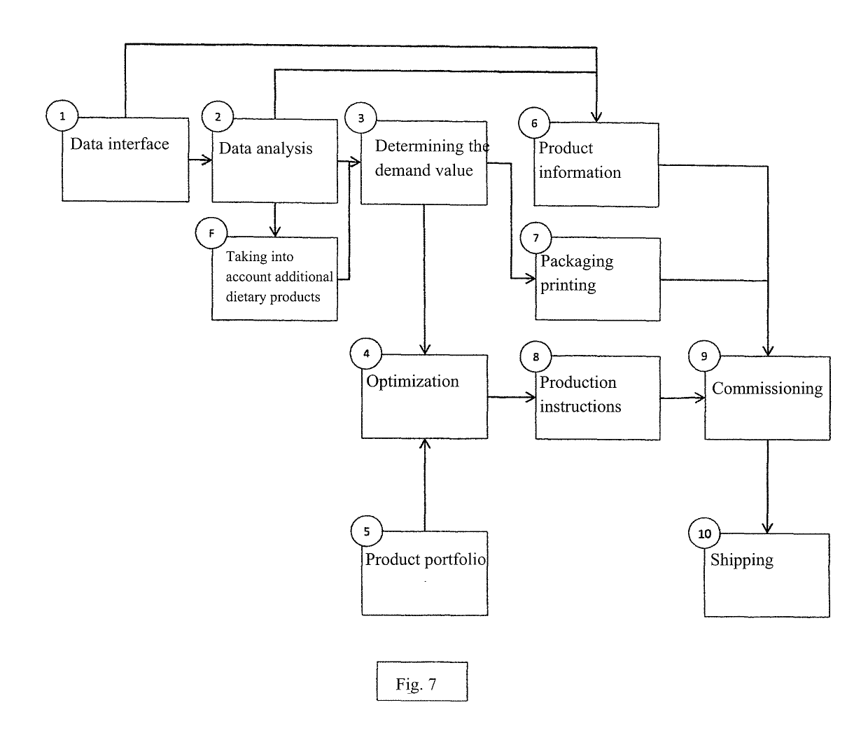

The seventh embodiment example represented schematically in FIG. 7 follows the method of the first embodiment example. Alternately or in addition to the first embodiment example, there is the option of taking into account additional feeding components when determining the demand values and finally calculating the rations, and incorporate said additional feeding components into the calculation of the rations (Step F). (For example, preparation of rations in combination with raw feeding for the dog; horse feeding in combination with basic feed such as grass and hay).

The embodiment examples can be readily combined with one another. In particular the alternatives or supplements in the embodiment examples can be realized either partially or completely in one embodiment.

1. Method for preparing a pet food product for a pet, with the method comprising the following steps:
Providing pet-specific information;
Processing the pet-specific information;
Creating a set of pet-specific pet food compositions based on the processed pet-specific information;
Preparing a pet food product based on the set of pet-specific pet food compositions;
with the pet food product consisting of an assortment of a plurality of rations, each of which has an assigned time.

2. Method according to claim 1,
with the pet-specific information being provided by a pet owner.

3. Method according to claim 1, with the rations being packaged individually, and each being labeled with information about the assigned time.

4. Method according to claim 1, with the food quantity and/or the food composition of the individual rations in the pet food product being individually adapted taking into account the respective assigned time.

5. Method according to claim 1, with the assigned time of the respective ration comprising a specific day, in particular a specific day of the week.

6. Method according to claim 1, with the pet food product, which consists of a set of rations, being commissioned and forwarded to the pet owner, in particular shipped.

7. Method according to claim 2, with the pet-specific information provided by the pet owner being entered via an electronic interface, in particular a Web-based portal.

8. Method according to claim 1, with the set of pet-specific information including one or more of the following details:
type of domestic pet;
pet's breed;
pet's age;
pet's name;
pet's diseases;
pet's allergies;
pet's intolerances;
pet's predispositions;
pet's size;
pet's physiological stress profile;
pet's breeding profile;
pet's lactation week;
number of pet's puppies;
pet's weight;
pet's nutritional state.

9. Method according to claim 1, with the set of pet-specific information being processed taking into account veterinary guidelines.

10. Method according to claim 1, with the creation of the set of pet-specific pet food compositions including a choice of semi-finished products and/or raw materials.

11. Method according to claim 1, with the set of pet-specific pet food compositions being created in an automated fashion.

12. Method according to claim 11, with the set of pet-specific pet food compositions being optimized by way of manual intervention as it is created.

13. Method according to claim 1, with supplementary feedings as addition to the provided pet food product being taken into account when creating the set of pet-specific food compositions.

14. Method according to claim 1, with recommendations for species-specific supplementary food and/or species-specific products and/or species-specific services being determined based on the pet-specific information, and in particular, said recommendations being made available to the pet owner together with the pet food product.

15. Method according to claim 1, with the individual ration packages assembled as pet food product being labeled with at least one of the following details:
Name of the individual pet;
at least part of the pet-specific information;
information about the pet food composition and/or the food quantity of the individually packaged ration;
information about the assigned time of the individually packaged ration.

16. Method according to claim 1, with the pet food product consisting of individually packaged daily rations for one week.

17. Pet food product for a pet, consisting of an assortment of a plurality of rations, each of which is labeled with an assigned time, provided by a method according to claim 1.
